(19) United States
(12) Patent Application Publication
(10) Pub. No.: US 2010/0194873 A1
(43) Pub. Date: Aug. 5, 2010

(54) METHOD AND DEVICE FOR MICROSCOPICALLY EXAMINING A SAMPLE, COMPUTER PROGRAM AND COMPUTER PROGRAM PRODUCT

(76) Inventors: Friedrich W. Viereck, Munich (DE); Christof Krug, Munich (DE)

Correspondence Address: HOFFMAN WARNICK LLC, 75 STATE STREET, 14TH FLOOR, ALBANY, NY, 12207, US

(21) Appl. No.: 12/668,934

(22) PCT Filed: May 16, 2008
(86) PCT No.: PCT/EP08/03966

§ 371 Date: Jan. 13, 2010

(30) Foreign Application Priority Data
Jul. 19, 2007 (DE) 10 2007 033 793.2

(51) Int. Cl. H04N 7/18

(52) U.S. Cl. 348/79

(57) ABSTRACT

The invention relates to a method for microscopically examining a sample, wherein, in an overview mode, first an overview image of the sample composed of a large number of individual images is recorded through a microscope (20) followed by a transition to a detail mode, in which detail images of regions of interest of the sample are recorded through said microscope. The method is characterized in that the recording of the overview image in the overview mode is carried out at a lower resolution of the respectively used camera than that employed for the recording of the detail images and that the overview image and the detail images are recorded using the same microscope objective. Furthermore, the invention relates to a device for microscopically examining a sample, a computer program and a computer program product.

The present invention relates, in a first aspect, to a method for microscopically examining a sample as defined in the pre-characterizing clause of claim 1.

In a further aspect, the invention relates to a device for microscopically examining a sample as defined in the pre-characterizing clause of claim 12.

Finally, the invention relates to a computer program and a computer program product.

WO 2006/028439 A1 describes a data management system and an associated method for processing, storing, and viewing the extremely large amount of imagery data produced by a matrix-based microscope slide scanner. The data are received as a series of overlapping image stripes and are assembled to form a seamless and contiguous image.

WO 2004/077338 A2 discloses a system based on the method for viewing “virtual slides”. The virtual-slide image data are stored on a virtual slide image server. When an image viewing program requests image data at a particular resolution, the image server supplies said program with image data at a resolution near to that requested, and the said program then scales the image data to the requested resolution.

WO 03/105675 A2 deals with a method of automatically detecting an image of a structure of interest in a tissue sample. The sample is imaged with the aid of a computer at two different resolutions by means of different lenses.

WO 98/39728 deals with a method and an apparatus for creating a virtual microscopic slide. This virtual microscopic slide is created with the aid of a computer-controlled microscope, which creates a plurality of low-resolution images of a sample and tiles the same together to create a total image. Furthermore, a lens is also used to create images of higher resolution, which are likewise tiled together to create a total image.

WO 01/84209 A2 describes a fully automatic rapid slide scanner which uses only one objective. In this case, the image is created at the highest resolution and then further processed digitally to provide other formats of different resolutions.

U.S. Pat. No. 6,522,774 describes a generic method which comprises the following method steps: firstly an overview image of the sample is created through a microscope in an overview mode, said overview image being composed of a plurality of individual images, followed by a transition to a detail mode, in which detail images of regions of interest of the sample are recorded through the microscope.

A generic apparatus likewise disclosed in U.S. Pat. No. 6,522,774 comprises the following components: a microscope, at least one camera fitted to the microscope for producing microscopic images, and a control and evaluation unit for controlling the microscope and the at least one camera, the control and evaluation unit being operable in an overview mode for recording an overview image of the sample, said overview image being composed of a plurality of individual images, and in a detail mode for recording detail images of regions of interest of the sample.

In U.S. Pat. No. 6,522,774, an overview image of a microscopic preparation is recorded which does not completely fit into the field of view of the camera and the microscope. The overview image is therefore composed of a plurality of individual images, also referred to as “tiles”. These image tiles are successively recorded by moving the preparation together with the sample stage and are then tiled together to form a tessellated image. In order to rapidly obtain an overview image showing a comparatively low degree of magnification, a few image tiles of low magnification are recorded. The regions of interest can then be selected with reference to the overview image. To examine the selected regions, the microscope is switched to an objective of greater magnifying power, and the same camera and the same beam path of the microscope are now used to record the detail images, which are then tiled together, if required, to form images showing greater detail.

The method described above necessitates carrying out numerous individual steps to achieve the final detail images of interest. Furthermore, a comparatively high-quality microscope is required which again comprises a plurality of objectives having different magnifying powers.

It is an object of the invention to provide a method and a device which simplify the recording of the detail images.

This object is achieved with the aid of the method having the features of claim 1 and by means of the device having the features of claim 12.

The computer program having the features of claim 18 and the computer program product having the features of claim 19 also form part of the invention.

Preferred variants of the method of the invention and preferred embodiments of the device of the invention are the subject matter of the dependent claims.

The method of the kind mentioned above is improved, according to the invention, in that the recording of the overview image in the overview mode is at a lower resolution of the camera respectively used in comparison to the recording of the detail images, and that the overview image and the detail images are recorded using the same microscope objective.

The device of the type defined above is further improved, according to the invention, in that the camera used in the overview mode has a lower resolution than that used in the detail mode and that the overview image and the detail images can be recorded or created using the same microscope objective.

In the preliminary work leading to the invention, it was first found that an important restrictive factor influencing the transition from the overview mode to the detail mode is in each case the changeover of the microscope objective.

The inventors further found that a microscope objective of high magnifying power can be basically used for the recording of the total image and, additionally, that the resolution of the digital camera can be reduced in the overview mode.

Finally, it has been found that the information required for an overview image could also be provided at a reduced camera resolution.

Thus the central idea of the invention is the recording of the overview image and the detail images using the same microscope objective and, furthermore, the use of a reduced resolution of the digital camera when working in the overview mode.

It is thus possible, on the one hand, to toggle between the overview mode and the detail mode much more quickly, since it is no longer necessary to change the microscope objective. This on the whole considerably accelerates and simplifies the recording of detail images.

On the other hand, numerous other advantages are gained from the fact that it is possible to avoid changing the objective. The relevant mechanical components can all be dispensed with, which cuts down costs considerably. Thus there is no moving mechanical system which could form a source of trouble. Finally, the difficulties hitherto encountered with regard to image misalignments no longer arise and there is also no requirement for refocusing otherwise necessary when changing the microscope objective. These advantageous properties are particularly significant when this method is used on “slide readers”, which can then be equipped with a stationary optical system.

Furthermore, the method of the invention can be carried out, in principle, with a microscope comprising only one objective. One special advantage of the invention therefore consists in the ability to use simpler and more cost-effective microscopes. For example, the method of the invention allows for the development of cost-effective automatic recording systems for microscopic preparations.

Considerable simplification is therefore achieved over the prior art, which has hitherto always involved the necessity of working with an automatic objective revolver and at least two objectives.

On the whole, the invention results in considerable advantages with respect to reliability, speed, costs and user friendliness.

It is therefore an essential feature of the invention that the overview image, which can also be referred to as an orientation image and the detail images, which can also be referred to as analysis images, are recorded by the same objective and, in particular, the same degree of optical magnification. Due to the new read-out mode of the invention, the images or the individual tiles or individual images from which the total images are created, have different resolutions.

In very general terms, the term camera is to be understood in the present invention to mean both the digital camera actually used and a camera system comprising said digital camera and a camera adapter. This camera adapter, which can have further optical properties, will be described in detail below.

The microscope images can basically be recorded in two different modes. In a start/stop imaging mode, the microscope stage moves toward any desired imaging position, stops there and the camera then records an image through the microscope before the microscope stage moves on to the next desired imaging position.

However, a so-called continuous imaging mode is particularly preferred. In this case, the microscope stage travels line-by-line or column-by-column or with any other prescribed motion above or below the preparation, and, triggered, for example, by the positional information of the stage, microscope images are recorded by the camera through the microscope during the movement of the stage. This mode is much faster than the start/stop mode. If necessary, focusing of the microscope must be adjusted automatically during the continuous movement of the stage.

The production of the overview image, in particular, can thus be faster if the sample stage of the microscope is moved continuously at least during certain phases of the imaging process.

In an advantageous variant, the sample stage is continuously moved, for example, at least column-by-column or line-by-line during the imaging process.

In the continuous imaging mode, a flashlight triggered by the camera is preferably used instead of continuous illumination in order to prevent blurring caused by the movement of the sample stage. This has the additional advantage that the camera itself need not be equipped for very short exposure times, and thus cost-effective cameras can be used for the device of the invention. Advantageously, the sample is therefore exposed to light from a pulsed light source.

No flashlight is required for recording the overview image, since the images need not be displayed or viewed at high resolution and therefore any blurring possibly resulting from movement of the sample stage is negligible.

In a particularly preferred embodiment of the device of the invention, the resolution of the camera for the overview mode can be lower than that used for the detail mode. For example, a camera is used which can be operated in a binning mode. Camera binning or pixel binning means that the light intensities of a number of pixels on the CCD sensor are summated to form an effectively larger pixel. This method brings about a reduction in the resolution and an increase in the quantity of light per pixel. The resulting image is a digital size reduction of the camera image without an optical size reduction being necessary for this purpose.

In an advantageous variant of the method of the invention, the overview image and the detail images are therefore recorded by the same camera, the camera being operated in a binning mode for the recording of the overview image, whilst the binning of the camera is reduced for subsequent recording of the detail images. The shorter read-out time of the camera chip makes possible a higher speed of recording in the binning mode.

These variants are characterized in that no high demands are placed on the microscope used, since only one camera is needed.

In a simple variant, the camera is operated in the highest binning mode for recording the overview image, and the binning of the camera is switched off for recording the detail images. For example, the binning of the camera can be 5×5 sensor pixels for recording the total image. Preferably, the continuous mode is selected as the mode for recording the total image. Since the volume of data is distinctly reduced by such binning, the individual images can be recorded extremely rapidly. The time required for recording the total image can therefore be of the same order of magnitude as would be the case if the total image had been recorded using an objective of substantially lower magnifying power. For example, one pixel in an overview image acquired using a 40× objective and 5×5 binning will be as large as that produced in an overview image using an 8× objective.

In principle, intermediate stages are also possible. For example, it may be advantageous and desirable for certain applications to retain a defined binning for the detail images also. That is to say, the camera will not be operated at the highest resolution. If there is sufficient time and capacity available for data processing, a total image can also be recorded with a higher information density, that is to say, at a higher resolution, without operating the camera in the highest binning mode for this purpose.

As an alternative to a reduction in the number of points for a constant field of view of the camera, the camera resolution can also be reduced by an enlargement of the field of view with the number of points remaining unchanged. In a preferred variant of the method of the invention, a field of view of the camera used for the overview mode is accordingly enlarged by means of an optical component for reducing the resolution for the overview mode over and against that used for the detail mode. For example, the size of the field of view of the camera can be changed in a desired manner by placing a zoom adapter in front of the camera used for recording the total or overview image for the purpose of enlarging the field of view. As an addition or alternative to a zoom adapter, a simple camera adapter containing a reduction stage can be used as an optical component for enlarging the field of view.

Furthermore, a first camera can be used for recording the overview image and a second camera can be used for recording the detail images, the first camera having a larger field of view than the second camera. For this purpose, the microscope comprises a separate camera output, and an enlargement of the field of view can be achieved by a reducing camera adapter placed in front of the first camera. The field of view of the camera can thus be enlarged and the recording of the overview image accelerated without changing the objective.

Advantageously, a tilting mirror that can be controlled by the control and evaluation unit is present in this embodiment for toggling between the first and second cameras.

In principle, the field of view of the camera used for recording the overview image can also be enlarged in the variant of the method of the invention in which the overview image and the detail images are recorded using the same microscope objective. For this purpose, e.g. a zoom adapter, which can, in particular, be driven by a motor, can be fitted in front of the camera used for recording the overview image. As a result, the field of view of the camera can likewise be enlarged and the recording of the overview image can be accelerated.

A user can determine and select the regions of interest on the sample interactively and alternatively or additionally by means of image analysis methods with reference to an overview image acquired in the first method step.

Starting from the regions thus defined, detail images can be recorded at higher resolution without changing the objective. For the production of such detail images, either of the two recording modes described above, that is to say, the start/stop mode or the continuous mode, can be selected. The binning of the camera can be switched off, to advantage, in order to achieve a high resolution of the detail images.

In a particularly user-friendly variant of the method of the invention, the overview image acquired is displayed on a computer monitor and used for interactive navigation on the sample for selecting the regions of interest. Such interactive navigation across the preparation can also be carried out during detailed imaging, that is, image recording at greater magnification.

The method of the invention is implemented on a microscope system, in particular, on a device of the invention, a computer being present as control and evaluation unit. The recording and assembly of the individual images, also referred to as tiles, in the overview and detail modes are therefore carried out in practice under computer control using the computer program of the invention as defined in claim 18, which can be advantageously stored as a computer program product on a data carrier as defined in claim 19.

Additional advantages and features of the method of the invention and the device of the invention will be explained below with reference to the diagrammatic figures, in which:

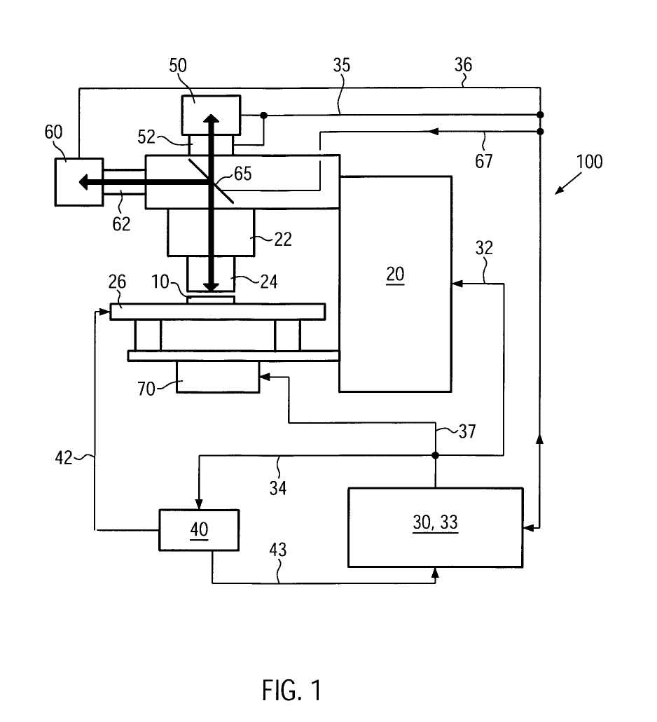

FIG. 1 is a diagrammatic view of an exemplary embodiment of the device of the invention; and

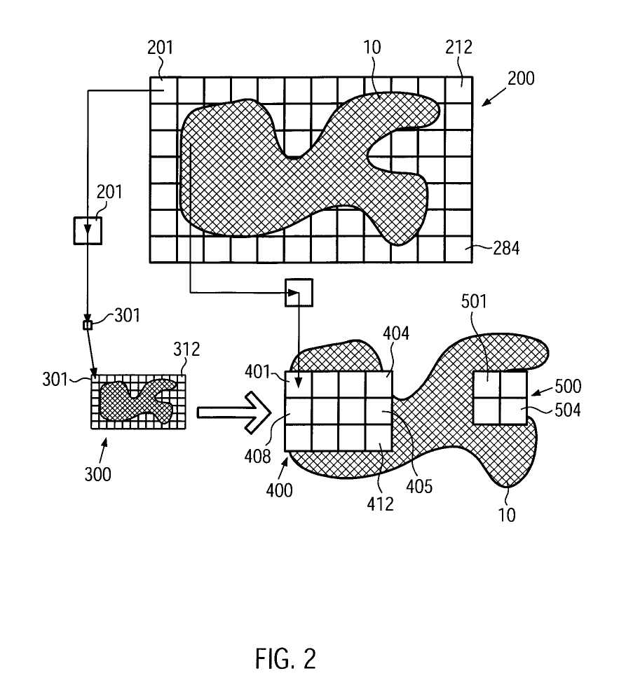

FIG. 2 is a diagrammatic representation of a variant of the method of the invention.

The essential components of the device of the invention 100 shown diagrammatically in FIG. 1 include a microscope 20, a first camera 50, a second camera 60, and a computer 33 as a control and evaluation unit 30 for controlling and evaluating information provided by the microscope 20, the first camera 50, and the second camera 60. According to the invention, the control and evaluation unit 30 can be operated in an overview mode for recording an overview image 300 of the sample 10 and in a detail mode for recording detail images 401, . . . , 412, 501, . . . , 504 of regions of interest 400, 500 in the sample 10. The microscope 20 shown diagrammatically comprises a tube 22, an objective 24 disposed thereon and a sample stage 26 that can be moved by means of motors. A microscopic preparation positioned on the sample stage 26 in the form of a sample 10 can be illuminated by means of an illuminating device 70 which, in particular, is operating in a pulsed mode. An arrangement operating with transmitted light is shown in FIG. 1. The concept of the invention can be applied to any other illumination configuration and basically also to other contrast-providing principles.

The first camera 50 is connected via a camera adapter 52 to the microscope 20. The second camera 60 is connected via a camera adapter 62 to the microscope 20. Apart from mechanically coupling the camera to the microscope-assembly, the camera adapters 52, 62 can perform an optical function and therefore form part of the camera system. In order to provide a desired reduction in the field of view of the camera system, the camera adapters 52, 62 can contain a size reducing optical system. Optionally, the camera adapter 52 can also be a zoom adapter 52. Typically, such a zoom adapter 52 can comprise a variable optical system in which a size reduction in the range from 0.3 to 1 is possible. To toggle between the first camera 50 and the second camera 60, a tilting mirror 65 is present in the microscope 20, which tilting mirror can be controlled by the control and evaluation unit 30 via a connecting line 67. The first camera 50 can be operated in different binning modes that can be set by the control and evaluation unit 30 via a connecting line 35. The same connecting line 35 can also be used for control of the other camera functions and for returning the image data recorded by the first camera 50 to the control and evaluation unit 30.

Accordingly, a connecting line 36 is used for control of the second camera 60 and for the transfer of image data from the second camera 60 to the control and evaluation unit 30.

The microscope 20 is connected via a connecting line 32 to the control and evaluation unit 30 for controlling and reading out status information, for example. For the purpose of controlling the sample stage 26, a stage control system 40 is present which transmits the required control signals to the stage 26 via a connecting line 42. The stage control system 40, which in turn is controlled by the control and evaluation unit 30 via a line 34, returns status information, particularly positional information, to the control and evaluation unit 30 via an additional line 43.

Finally, the activity of the illuminating device 70 can be controlled by the control and evaluation unit 30 via a connecting line 37. In this way, the control and evaluation unit 30 can determine whether a pulsed mode or a continuous mode is used.

A variant of the method of the invention and accordingly of the computer program of the invention is described below with reference to FIGS. 1 and 2.

In a first step, a microscopic preparation is first positioned on the sample stage 26 in the form of a sample 10. The microscope 20 in the example illustrated comprises only one objective, for example a 40× objective. The computer 33 then switches the first camera 50 to binning 5×5. In the subsequent method step, the computer 33 calculates the positions of the sample stage for all of the individual images or image tiles 201, . . . , 212, . . . , 284 of a total image of the sample 10. The computer 33 then positions the sample stage 26 with the aid of the stage control system 40 toward the upper left-hand corner of the sample 10, that is to say, the upper left-hand corner of the individual image 201. Instead of the image 201, the image 301 having a number of pixels that is smaller by a factor of 5×5=25 is actually recorded due to the binning adjusted in the first camera 50. The overview image 300 actually recorded is thus smaller than the total image 200 by a factor of 25. This is diagrammatically indicated by an appropriately smaller representation in FIG. 2.

The computer 33 then moves the sample stage 26 parallel to the x-axis toward the right up to the end of the line. During the movement of the sample stage 26, respective positional signals are returned by the stage control system 40 to the computer 33. At predefined positional signals, that is to say, at predefined tile positions, an image is recorded using a short exposure time of the first camera 50. A pulsed illumination is not necessary in this case, since the overview image 300 will already be recorded only at relatively low resolution. When the end of a line is reached, the sample stage 26 travels one line of image tiles downwardly and moves back as described above, but in the reverse direction of the x-axis and, in doing so, records the next line of image tiles, that is to say, the individual images 313 to 324. This process is repeated until the complete overview image 300 comprising all of the individual images 301 to 384 has been recorded. The overview image 300 acquired in this way is used by the user for the interactive selection of areas or regions of interest on the sample. The computer 33 then switches the first camera 50 to zero binning.

In addition to this mode of moving through the individual lines of image tiles, in which the direction of movement of the sample stage changes after each line, the images can also be recorded in a so-called “combing mode”. In this case, the sample stage moves back to the start of the line after passing through each line of image tiles and then passes through the next line of image tiles. The combing mode may be preferable when particularly high accuracy of positioning is required.

In an alternative embodiment of the device, the camera adapter 52 is a zoom adapter 52. Instead of using different binning modes for the first camera 50, a larger field of view can in this case be adjusted with the help of the zoom adapter 52, this likewise corresponding to a reduced number of points per surface area of the field of view, that is to say, to reduced resolution. In principle, enlargement of the field of view can also be achieved by combining the effect of a zoom adapter with defined binning.

For example, regions 400, 500 can be identified as regions of interest. The computer 33 then calculates the positions of the sample stage 26 for all of the individual images 301 to 384 of the detail image. Following selection of the regions of interest 400, for example, the computer 33 navigates the sample stage 26 toward the upper left-hand corner of the selected region of interest 400, that is to say, toward the upper left-hand corner of the individual image 401 in the region 400. The computer 33 then moves the sample stage 26 parallel to the x-axis toward the right to the end of the region 400, that is to say, to the right-hand edge of the individual image 404 in the region 400. During this movement of the sample stage 26, a positional signal of the sample stage 26 is continuously returned to the computer 33 by the stage control system 40. At each predefined tile position, an image is recorded using a short exposure time. Furthermore, the illuminating unit 70 is advantageously operated in the pulsed mode for this purpose in order to avoid blurring of the images due to the sample movement. Once the sample stage has passed through the first line of image tiles, the images 401 to 404 are recorded. The sample stage 26 is then moved downwardly by one line of image tiles, and the image tiles 405 to 408 are then recorded. This process is repeated until all of the individual images 401 to 412 have been recorded for the region of interest 400. The detail images for the additional selected region of interest 500 with its individual images 501 to 504 are recorded in similar fashion. Here again, as already described above, the sample stage can pass through the successive lines in alternating directions. If particularly high demands are placed on positional accuracy, the combing mode is likewise possible in which the sample stage travels back to the start of the line of image tiles and traverses all lines in the same direction.

Alternatively, the second camera 60 might be used for recording the detail images and the tilting mirror 65 actuated via the control and evaluation unit 30 for toggling between the first camera 50 and the second camera 60.

The present invention provides a novel method for microscopically examining a sample and a corresponding device, which can be used for more rapid execution of microscopic examination of said samples, in which detail images are required to be generated based on an overview image. This can be achieved with a smaller amount of equipment than that used in the prior art.

1-19. (canceled)

20. A method of microscopically examining a sample,
wherein, in an overview mode, first an overview image of the sample composed of a large number of individual images is recorded through a microscope followed by a transition to a detail mode, in which detail images of regions of interest in the sample are recorded through the microscope,
wherein
the recording of the overview image in the overview mode is carried out at a lower resolution of the respectively used camera than that employed for the recording of the detail images and
the overview image and the detail images are recorded using the same microscope objective.

21. The method as defined in claim 20,
wherein
the overview image and the detail images are recorded using the same camera,
the camera is operated in a binning mode for the recording of the overview image and
the binning of the camera is reduced for the purpose of subsequent recording of the detail images.

22. The method as defined in claim 21,
wherein
the camera is operated in the highest binning mode for the purpose of recording the overview image and
the binning of the camera is switched off for the purpose of recording the detail images.

23. The method as defined in claim 20,
wherein
for effecting a reduction of the resolution for the overview mode compared with the detail mode a field of view of the camera used for the overview mode is enlarged by means of an optical component.

24. The method as defined in claim 23,
wherein
the field of view of the camera used for the overview mode is enlarged by means of at least one of a zoom adapter and a camera adapter.

25. The method as defined in claim 23,
wherein
a first camera is used for the recording of the overview image and a second camera is used for the recording of the detail images which first camera has a larger field of view than the second camera.

26. The method as defined in claim 20,
wherein
for effecting a reduction of the resolution for the overview mode compared with the detail mode a field of view of the camera used for the overview mode is enlarged by means of an optical component,
a first camera is used for the recording of the overview image and a second camera is used for the recording of the detail images which first camera has a larger field of view than the second camera and
the larger field of view is attained by a size-reducing camera adapter placed in front of the first camera.

27. The method as defined in claim 20,
wherein
for effecting a reduction of the resolution for the overview mode compared with the detail mode a field of view of the camera used for the overview mode is enlarged by means of an optical component,
the field of view of the camera used for the overview mode is enlarged by means of at least one of a zoom adapter and a camera adapter,
a first camera is used for the recording of the overview image and a second camera is used for the recording of the detail images which first camera has a larger field of view than the second camera and
the larger field of view is attained by a size-reducing camera adapter placed in front of the first camera.

28. The method as defined in claim 20,
wherein
a sample stage of the microscope is moved continuously at least during certain phases of the imaging process.

29. The method as defined in claim 28,
wherein
the sample stage is continuously moved at least column-by-column or line-by-line during the imaging process.

30. The method as defined in claim 20,
wherein
the sample is illuminated by a pulsed light source.

31. The method as defined in claim 30,
wherein
the overview image is used for interactive navigation across the sample for the purpose of selecting the regions of interest.

32. The method as defined in claim 20,
wherein
a device for microscopic examination of a sample is used,
the device for microscopic examination of a sample comprising:
a microscope,
at least one camera fitted to the microscope for the purpose of recording microscopic images, and
a control and evaluating unit for the purpose of controlling the microscope, and the at least one camera,
wherein the control and evaluation unit can be operated in an overview mode for the recording of an overview image of the sample composed of a large number of individual images and in a detail mode for recording of detail images of regions of interest in the sample,
wherein
in the overview mode the camera used has a lower resolution than that employed in the detail mode and
the overview image and the detail images can be recorded using the same microscope objective.

33. A device for microscopic examination of a sample, comprising:
a microscope;
at least one camera fitted to the microscope for the purpose of recording microscopic images; and
a control and evaluating unit for the purpose of controlling the microscope, and the at least one camera;
wherein the control and evaluation unit can be operated in an overview mode for the recording of an overview image of the sample composed of a large number of individual images and in a detail mode for recording of detail images of regions of interest in the sample,
wherein
in the overview mode the camera used has a lower resolution than that employed in the detail mode and
the overview image and the detail images can be recorded using the same microscope objective.

34. The device as defined in claim 33,
wherein
the resolution of the camera for the overview mode can be reduced compared with the detail mode by pixel binning.

35. The device as defined in claim 33,
wherein
a zoom adapter is placed in front of the camera used for the recording of the overview image for the purpose of enlarging the field of view thereof.

36. The device as defined in claim 34,
wherein
a zoom adapter is placed in front of the camera used for the recording of the overview image for the purpose of enlarging the field of view thereof.

37. The device as defined in claim 33,
wherein
a first camera is present for the recording of the overview image and a second camera is present for the recording of the detail images, which first camera has a larger field of view than the second camera.

38. The device as defined in claim 37,
wherein
a mirror capable of being tilted and being controlled by the control and evaluation unit is present for the purpose of switching between the first camera and the second camera.

39. The device as defined in claim 37,
wherein
the first camera has a size-reducing camera adapter.

40. The device as defined in claim 33,
which is designed for carrying out a method of microscopically examining a sample,
wherein, in an overview mode, first an overview image of the sample composed of a large number of individual images is recorded through a microscope followed by a transition to a detail mode, in which detail images of regions of interest in the sample are recorded through the microscope,
the recording of the overview image in the overview mode is carried out at a lower resolution of the respectively used camera than that employed for the re-cording of the detail images and
the overview image and the detail images are recorded using the same microscope objective.

41. A computer program for microscopically examining a sample when the computer program is carried out on a computer,
wherein
the computer program is carried out on a control and evaluating unit for the purpose of controlling a microscope and at least one camera,
the control and evaluation unit can be operated in an overview mode for the recording of an overview image of the sample composed of a large number of individual images and in a detail mode for recording of detail images of regions of interest in the sample,
in the overview mode the camera used has a lower resolution than that employed in the detail mode, and
the overview image and the detail images are recorded using the same microscope objective.

42. A computer program product stored on a computer-readable data medium, the computer program product comprising a computer program for microscopically examining a sample, when the computer program is carried out on a computer, wherein
the computer program is carried out on a control and evaluating unit for the purpose of controlling a microscope, and at least one camera,
the control and evaluation unit can be operated in an overview mode for the recording of an overview image of the sample composed of a large number of individual images and in a detail mode for recording of detail images of regions of interest in the sample,
in the overview mode the camera used has a lower resolution than that employed in the detail mode and
the overview image and the detail images can be recorded using the same microscope objective.
